(19) United States
(12) Patent Application Publication
(10) Pub. No.: US 2025/0158909 A1
(43) Pub. Date: May 15, 2025

(54) METHOD AND DEVICE FOR RECORDING TRAFFIC, STORAGE MEDIUM AND COMPUTER DEVICE

(71) Applicant: GUANGZHOU PINWEI SOFTWARE CO., LTD., Guangzhou (CN)

(72) Inventor: Wei XU, Guangzhou (CN)

(73) Assignee: GUANGZHOU PINWEI SOFTWARE CO., LTD., Guangzhou (CN)

(21) Appl. No.: 18/733,917

(22) Filed: Jun. 5, 2024

(30) Foreign Application Priority Data
Nov. 13, 2023 (CN) 202311499036.4

(51) Int. Cl. H04L 43/0876; H04L 43/091

(52) U.S. Cl. CPC H04L 43/0876; H04L 43/091

(57) ABSTRACT

A method for recording traffic and device, a storage medium and a computer device are provided. The method includes: receiving service requests issued by application clients of the target application within a preset time period; obtaining a request interface and request parameters corresponding to each of the service request; obtaining a feature table, where the feature table includes multiple request interfaces and feature fields corresponding to the multiple request interfaces; obtaining a recording data table in a case that the request interface corresponding to each of the service request meets the preset condition; recording the service request in a case that the request interface corresponding to the service request is not included in the recording data table; and writing the recorded data into the recording data table.

### CROSS REFERENCE OF RELATED APPLICATION

This application claims priority to Chinese Patent Application No. 202311499036.4, titled “METHOD AND DEVICE FOR RECORDING TRAFFIC, STORAGE MEDIUM AND COMPUTER DEVICE”, filed on Nov. 13, 2023 with the China National Intellectual Property Administration, which is incorporated herein by reference in its entirety.

### FIELD

The present disclosure relates to the technical field of automatic testing, and in particular to a method for recording traffic and a device for recording traffic, a storage medium and a computer device.

### BACKGROUND

Traffic recording and replay can be used to test application interfaces, in which practical requests of an online user and responses to the request are obtained without affecting the normal operation at the user end, and the requests and the responses are saved and used as test cases. The traffic recording offers a significant advantage in reducing the cost of constructing test data and writing test cases compared with conventional automatic test on interfaces. By considering traffic as test cases, online traffic can be directly used as cases for testing interfaces, thereby eliminating time-consuming and laborious work such as test data preparation and script writing.

Currently, traffic requests saved during traffic recording are highly specific. Generally, a rule of the traffic recording is configured based on the request structure of one application client of a target application. For a same request interface, it is difficult to replay traffic data recorded based on one application client in another application client of the target application. As a result, the universality of data obtained through traffic recording is unsatisfied, which compromises the testing efficiency.

### SUMMARY

In the present disclosure, it is interested in at least one of the above technical problems, in particular to the problem in the conventional technology that, for a same request interface, it is difficult to replay traffic data recorded based on one application client in another application client of the target application, resulting in unsatisfied universality of data obtained through traffic recording and compromised testing efficiency.

In a first aspect, a method for recording traffic is provided according to the present disclosure. The method is applied to a server, and the method includes: receiving, in response to a traffic recording instruction for a target application, service requests issued by application clients of the target application within a preset time period; obtaining a request interface and request parameters corresponding to each of the service requests; obtaining a feature table, wherein the feature table includes multiple request interfaces and feature fields corresponding to the multiple the request interfaces, and the feature field is a parameter that is included and of a same value in each service request which is sent by each application client to each request interface corresponding to each application client; determining whether a request interface corresponding to each of the service requests meets a preset condition based on the feature table; obtaining a recording data table, in a case that the request interface corresponding to the service request meets the preset condition; determining whether the request interface corresponding to the service request is included in the recording data table; recording the service request, in a case that the request interface corresponding to the service request is not included in the recording data table; and writing the recorded data into the recording data table; where the determining whether the request interface corresponding to each of the service requests meets the preset condition based on the feature table includes: determining whether the request interface corresponding to the service request is included in the feature table; determining a target data record in a case that the request interface corresponding to the service request is included in the feature table, where the target data record is a data record that is in the feature table and corresponds to the request interface corresponding to the service request; determining whether the request parameters of the service request include a request parameter the same as a feature field corresponding to the target data record; determining that the request interface corresponding to the service request meets the preset condition, in a case that the request parameters of the service request include a request parameter the same as the feature field corresponding to the target data record; and determining that the request interface corresponding to the service request does not meet the preset condition, in a case that the request parameters of the service request do not include the request parameter the same as the feature field corresponding to the target data record.

In an embodiment, the method further includes: obtaining target request data at a scheduled time instant; determining a preset temporary table, where the target request data includes all data records in a log of a server at a current time instant, and where each of the data records in the log of the server includes a request interface, request parameters and return data; dividing, for the target request data obtained at the each time instant, the target request data into multiple request data sets based on the request interfaces included in the data records in the target request data, where the data records in a same request data set correspond to a same request interface; performing feature cleaning on each of multiple request data sets; determining whether there is a feature field corresponding to the request data set based on a result of the feature cleaning; writing, in a case that there is a feature field corresponding to the request data set, the request interface and the feature field corresponding to the request data set into the temporary table; updating log data of the server based on the temporary table; and updating the feature table based on the temporary table.

In an embodiment, the performing feature cleaning on each of the multiple request data sets includes: obtaining request parameters and return data corresponding to each of data records in the request data set; and determining a request parameter as the feature field corresponding to the request data set, in a case that the request parameter is included in each of the data records in the request data set and is of a same value in the return data corresponding to each of the data records in the request data set.

In an embodiment, the updating the log data of the server based on the temporary table includes: obtaining a first request interface, where the first request interface is a request interface corresponding to any one of the data records in the log data of the server; and deleting, in a case that the first request interface is not included in the temporary table, the data record corresponding to the first request interface from the log data of the server, to update the log data of the server.

In an embodiment, the updating the feature table based on the temporary table includes: obtaining a second request interface, where the second request interface is a request interface corresponding to any one of data records in the feature table; and updating, in a case that the second request interface is included in the temporary table, a feature field that is in the feature table and corresponds to the second request interface as a feature field that is in the temporary table and corresponds to the second request interface.

In an embodiment, the method further includes: obtaining all data in the recording data table when the preset time period ends, where the data in the recording data table is configured to perform replay testing on interfaces of the application clients.

In a second aspect, a device for recording traffic is provided according to the present disclosure. The device is applied to a server, and the device includes: a request receiving module, configured to receive service requests issued by application clients of a target application within a preset time period in response to a traffic recording instruction for the target application and obtain a request interface and request parameters corresponding to each of the service requests; a first obtaining module, configured to obtain a feature table, where the feature table includes multiple the request interfaces and feature fields corresponding to the multiple the request interfaces, and the feature field is a parameter that is included and of a same value in each service request which is sent by each application client to each request interface corresponding to each application client; a determination module, configured to determine whether a request interface corresponding to each of the service requests meets a preset condition based on the feature table; a second obtaining module, configured to obtain a recording data table in a case that the request interface corresponding to the service request meets the preset condition; and determine whether the request interface corresponding to the service request is included in the recording data table; and a request recording module, configured to record the service request in a case that the request interface corresponding to the service request is not included in the recording data table; and write the recorded data into the recording data table; where the determination module further configured to determine whether the request interface corresponding to the service request is included in the feature table; determine a target data record in a case that the request interface corresponding to the service request is included in the feature table, where the target data record is a data record that is in the feature table and corresponds to the request interface corresponding to the service request; determine whether the request parameters of the service request include a request parameter the same as a feature field corresponding to the target data record; determine that the request interface corresponding to the service request meets the preset condition, in a case that the request parameters of the service request include a request parameter the same as the feature field corresponding to the target data record; and determine that the request interface corresponding to the service request does not meet the preset condition, in a case that the request parameters of the service request do not include the request parameter the same as the feature field corresponding to the target data record.

In a third aspect, a computer-readable storage medium is provided according to the present disclosure. The computer-readable storage medium stores computer-readable instructions. Where, the computer-readable instructions, when executed by one or more processors, cause the one or more processors to implement the above method for recording traffic.

In a fourth aspect, a computer device is provided according to the present disclosure. The computer device includes a memory and one or more processors. The memory storing computer-readable instructions. Where, the computer-readable instructions, when executed by one or more processors, cause the one or more processors to implement the above method for recording traffic.

### BRIEF DESCRIPTION OF THE DRAWINGS

In order to more clearly describe technical solutions in the embodiments of the present disclosure or in the conventional technology, drawings to be used in the description of the embodiments or the conventional technology are briefly introduced hereinafter. It is apparent that the drawings described below demonstrate merely some embodiments of the present disclosure, and those skilled in the art can obtain other drawings based on the provided drawings without any creative effort.

FIG. 1 is a flowchart of a method for recording traffic according to an embodiment of the present disclosure;

FIG. 2 is a flowchart of a step of updating log data of a server and a feature table at a scheduled time instant according to an embodiment of the present disclosure;

FIG. 3 is a flowchart of a step of performing feature cleaning on each of request data sets according to an embodiment of the present disclosure;

FIG. 4 is a flowchart of a step of updating log data of a server according to an embodiment of the present disclosure;

FIG. 5 is a flowchart of a step of updating a feature table according to an embodiment of the present disclosure;

FIG. 6 is a flowchart of a step of determining whether a request interface meets a preset condition according to an embodiment of the present disclosure;

FIG. 7 is a schematic structural diagram of a device for recording traffic according to an embodiment of the present disclosure; and

FIG. 8 is a schematic diagram of an internal structure of a computer device according to an embodiment of the present disclosure.

### DETAILED DESCRIPTION OF THE EMBODIMENTS

Technical solutions in the embodiments of the present disclosure will be clearly and completely described below in conjunction with the drawings of the embodiments of the present disclosure. Apparently, the embodiments described below are only some embodiments of the present disclosure, rather than all the embodiments. Any other embodiments obtained by those skilled in the art based on the embodiments in the present disclosure without any creative effort fall within the protection scope of the present disclosure.

In an embodiment, a method for recording traffic is provided according to the present disclosure. The following embodiments illustrate that the method is applied to a server. It can be understood that the method for recording traffic may be performed by a single server or a server cluster composed of multiple servers, which is not limited in the present disclosure.

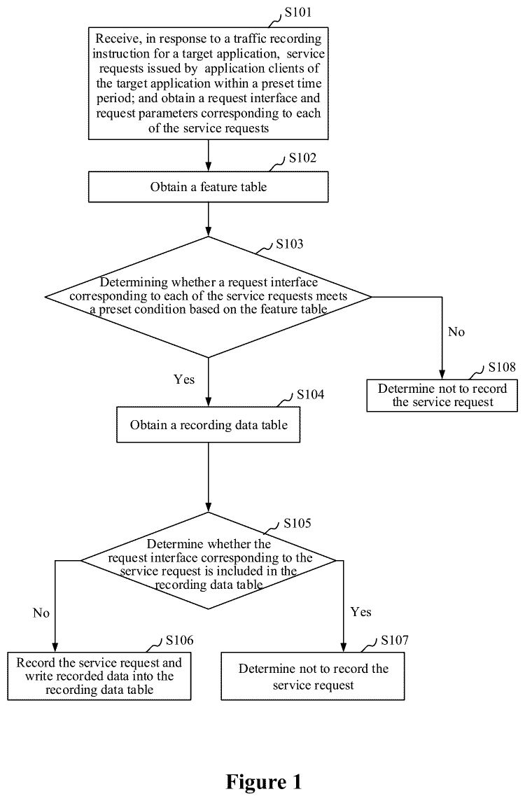

As shown in FIG. 1, a method for recording traffic is provided according to the present disclosure. The method is applied to a server and includes steps S101 to S108 as follows.

In step S101, in response to a traffic recording instruction for a target application, service requests issued by application clients of the target application within a preset time period are received, and a request interface and request parameters corresponding to each of the service requests are obtained.

Where, the preset time period is set by a tester according to a test task and test requirements, or is a default time period of the server, which is not limited in the present disclosure. The application client of the target application includes but is not limited to an Android terminal and an IOS terminal. The service request is regarded as a HTTP/HTTPS request composed of four parts, namely a request line, a request header, a blank line and a request body. The request line includes but is not limited to information such as a request mode, a uniform resource locator (URL), and a protocol version, etc. In an embodiment, the request interface of the service request may be obtained from the URL of the request line. The request parameters may be obtained from the request body in the service request or from the URL in the service request.

In this step, upon receiving the traffic recording instruction, the server determines a to-be-recorded object, i.e., the target application, for the traffic recording instruction. The service requests issued by application clients of the target application within the preset time period are received and the request interface and the request parameters corresponding to each of the service requests are obtained.

In an embodiment, the requests sent to the server within the preset time period are received. The client that issues the request is one of the application clients of the target application. In this case, it is in an online environment, and therefore the requests are real requests of the online user.

In step S102, a feature table is obtained.

Where, the feature table includes multiple request interfaces and feature fields corresponding to the multiple request interfaces. The feature field refers to a parameter that is included and is of a same value in each service request, where the each service request is sent by each application client to each request interface corresponding to each application client.

In this step, the feature table is obtained when the request interfaces and the request parameters of the service requests received within the preset time period are obtained, to determine whether to record the received service requests based on the feature table.

In step S103, for each of the service requests, it is determined whether a request interface corresponding to the service request meets a preset condition based on the feature table.

It can be understood that the feature table includes multiple request interfaces and feature fields corresponding to the request interfaces. Each request interface is compared with data in the feature table to determine whether the request interface meets the preset condition.

In step S104, a recording data table is obtained in a case that the request interface corresponding to the service request meets the preset condition.

Where, the recording data table is pre-created. A freshly created recording data table is an empty table. After data is written in step S106, the obtained recording data table includes written data. In other words, the obtained recording data table is a latest recording data table at a current obtaining time instant.

In step S105, it is determined whether the request interface corresponding to the service request is included in the recording data table.

By determining whether the request interface corresponding to the service request is included in the recording data table, it can determine whether the request interface has been requested by another application client of the target application. In a case that there is data corresponding to the request interface in the recording data table, it is determined that there is no need to record the service request. In a case that there is no data corresponding to the request interface in the recording data table, it is determined to perform traffic recording for the service request.

In step S106, in a case that the request interface corresponding to the service request is not included in the recording data table, the service request is recorded and recorded data is written in the recording data table.

Where, the recording data table includes multiple request interfaces and return data corresponding to each of the multiple request interfaces. In addition, the multiple request interfaces are different from each other. The recorded data includes but is not limited to a request interface, request parameters and return data of the service request.

As an example, a recording data table A is obtained, and the recording data table A is an empty table at an initial time instant. On reception of a service request B, it is determined whether a request interface a of the service request B is included in the recording data table A. In this case, the request interface a is not included in the recording data table A, and therefore the service request B is recorded and recorded data is written in the recording data table A. On reception of a service request C, it is determined whether a request interface b of the service request C is included in the recording data table A. In this case, the request interface b is not included in the recording data table A, and therefore the service request C is recorded and recorded data is written in the recording data table A. On reception of the service request D, it is determined whether a request interface b of the service request D is included in the recording data table A. Since the request interface b has already been included in the recording data table A, and therefore the service request D is not recorded.

In step S107, in a case that the request interface corresponding to the service request is included in the recording data table, traffic recording is not performed on the service request.

In an embodiment, in a case that the request interface corresponding to the service request is included in the recording data table, it indicates that the request data corresponding to the request interface has been recorded for the request interface corresponding to the service request, and therefore there is no need to record the current service request.

In step S108, in a case that the request interface corresponding to the service request does not meet the preset condition, the service request is not recorded.

The request interface corresponding to the service request is compared with the data in the feature table. In a case that the request interface corresponding to the service request does not meet the preset condition, the service request is ignored, i.e., the service request is not recorded.

In the method for recording traffic according to the present disclosure, a service request issued by each application client of a target application within a preset time period is received in response to a traffic recording instruction for the target application. A request interface and request parameters corresponding to each service request are obtained. A feature table is obtained. Where, the feature table includes multiple request interfaces and feature fields corresponding to the multiple request interfaces. The feature field refers to a parameter that is included and is of a same value in each service request which is sent by each application client to each request interface corresponding to each application client. For each of the service requests, it is determined whether a request interface corresponding to the service request meets a preset condition based on the feature table. A recording data table is obtained in a case that the request interface corresponding to the service request meets the preset condition. It is determined whether the request interface corresponding to the service request is included in the recording data table. In a case that the request interface corresponding to the service request is not included in the recording data table, the service request is recorded and recorded data is written in the recording data table. By recording the parameter, i.e., feature field, which is included and is of a same value in all the requests sent by different application clients of the target application to a same request interface, request data can be selectively recorded based on the request interface and the feature field corresponding to the request interface. By determining whether the request interface is included in the recording data table, the request interfaces in the recorded data are different from each other. In other words, for each request interface, only one copy of request data is recorded. In replay testing, the recorded data may be matched with the requests issued by each of application clients for interface testing. In other word, the request data corresponding to each request interface can be used to test the requests sent by multiple application clients to the request interface, thereby enhancing the universality of data obtained through traffic recording and the efficiency for testing application interfaces.

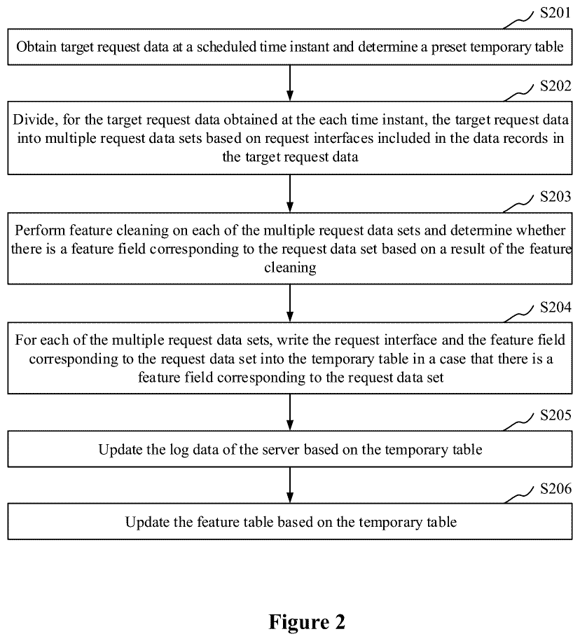

As shown in FIG. 2, in an embodiment, the method further includes steps S201 to S206 as follows.

In step S201, target request data is obtained at a scheduled time, and a preset temporary table is determined.

Where, the target request data includes all data records in a log of the server at present, and each piece of data records in the log of the server includes a request interface, request parameters and return data. The return data refers to data, in response to the request issued for the corresponding request interface, returned by the request interface to the application client who issued the request.

In this step, the preset temporary table is an empty table.

In step S202, for the target request data obtained at the each time instant, the target request data is divided into multiple request data sets based on request interfaces included in data records in the target request data.

For each of the multiple request data sets, data records in a same request data set correspond to a same request interface.

In an embodiment, data records corresponding to a same request interface are divided into a same request data set based on the request interfaces included in the data records in the target request data. Therefore, the target request data is divided into multiple request data sets based on the request interfaces included in the data records in the target request data.

For example, in a case that the target request data includes a data record A, a data record B, and a data record C. The data record A corresponds to a request interface a, the data record B corresponds to a request interface b, and the data interface C corresponds to a request interface a. Since the target request data is divided based on respective request interfaces corresponding to the data records in the target request data, the data record A and the data record C correspond to a same request interface. Therefore, the data record A and the data record C are divided into a same request data set, and the data record B is divided into another request data set.

In step S203, for each of multiple request data sets, feature cleaning is performed on the request data set; and based on a result of the feature cleaning, it is determined whether there is a feature field corresponding to the request data set.

Where, feature cleaning is performed on each of the request data sets by traversing all data records in each request data set and determining whether there is a request parameter matching the feature field in terms of definition.

In step S204, for each of the multiple request data sets, in a case that there is a feature field corresponding to the request data set, the request interface and the feature field corresponding to the request data set are written in the temporary table.

In step S205, based on the temporary table, log data of the server is updated.

Where, the log data of the server refers to all data in the log of the server.

In step S206, based on the temporary table, the feature table is updated.

It can be understood that the feature table is generated in advance according to a preset rule when the server responds to the traffic recording instruction for the target application for the first time.

By obtaining the log data of the server through a scheduled task and processing the obtained data to obtain the temporary table to update the log data of the server and the feature table based on the temporary table, data in the feature table can be updated in time. This can eliminate the low success rate in replay testing, which is based on data obtained through traffic recording, due to untimely updates.

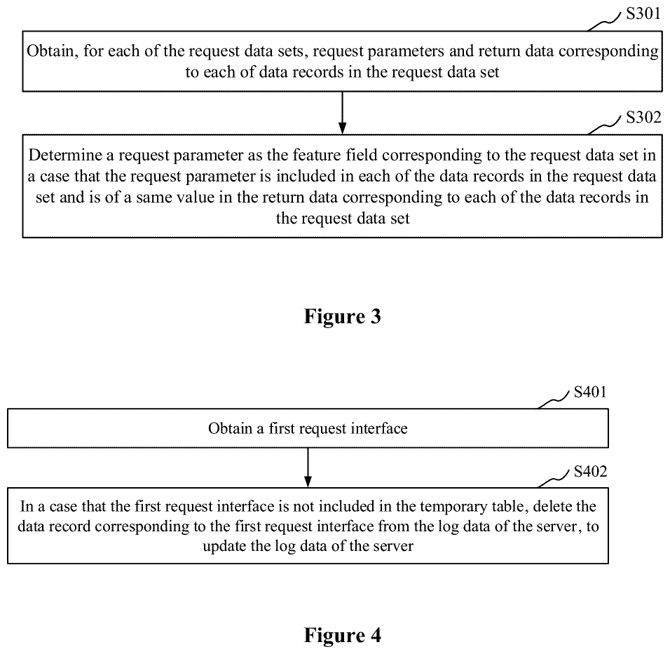

As shown in FIG. 3, in an embodiment, the process of performing feature cleaning on each request data set includes steps S301 and S302 as follows.

In step S301, for each of the request data sets, request parameters and return data corresponding to each of data records in the request data set are obtained.

In step S302, a request parameter is determined as the feature field corresponding to the request data set, in a case that the request parameter is included in all data records in the request data set and is of a same value in the return data corresponding to all data records in the request data set.

As an example, a request data set Q includes a data record A and a data record B. Request parameters corresponding to the data record A are brandid, androidRom, os Verison, and androidToken; and request parameters corresponding to the data record B are brandid, iosPhone, osVersion, and iosToken. Where, the value of the request parameter brandid corresponding to the data record A is equal to the value of the request parameter brandid corresponding to the data record B; and the value of the request parameter os Verison corresponding to the data record A is not equal to the value of the request parameter os Verison corresponding to the data record B. In this case, the request parameter brandid is determined as the feature field of the request data set Q.

As shown in FIG. 4, in an embodiment, the process of updating the log data of the server based on the temporary table includes steps S401 and S402 as follows.

In step S401, a first request interface is obtained.

Where, the first request interface is a request interface corresponding to any one of data records in the log data of the server.

In step S402, in a case that the first request interface is not included in the temporary table, the data record corresponding to the first request interface is deleted from the log data of the server, to update the log data of the server.

It can be understood that since the amount of the log data of the server is increased with the increase of received requests, it is required to update the log data of the server regularly to prevent excessive storage space and system resources from being occupied by the log data.

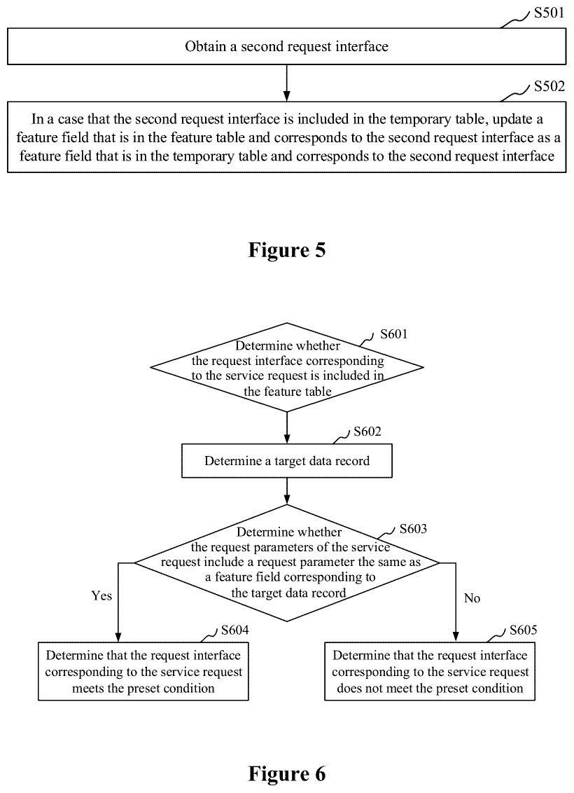

As shown in FIG. 5, in an embodiment, the process of updating the feature table based on the temporary table includes steps S501 and S502 as follows.

In step S501, a second request interface is obtained.

Where, the second request interface is a request interface corresponding to any one of data records in the feature table.

In step S502, in a case that the second request interface is included in the temporary table, a feature field, in the feature table, which is corresponding to the second request interface, is updated as the feature field corresponding to the second request interface in the temporary table.

As the version iteration of the target application occurs during its development, the iterated version may results in a change in the feature field corresponding to a request interface. Therefore, the request interfaces and feature fields corresponding to the request interfaces in the feature table are updated regularly to ensure that request data corresponding to each request interface can be used to test requests sent by multiple application clients to the request interface, thereby enhancing the universality of data obtained through traffic recording and the efficiency for testing application interfaces.

As shown in FIG. 6, in an embodiment, the process of determining whether the request interface corresponding to the service request meets the preset condition based on the feature table includes steps S601 to S605.

In step S601, it is determined whether the request interface corresponding to the service request is included in the feature table.

By determining whether the request interface is included in the feature table, it can determine whether to record the service request. In a case that the request interface corresponding to the service request is not included in the feature table, it indicates that traffic recording is not to be performed on the service request. In this way, selective record can be achieved.

In step S602, a target data record is determined in a case that the request interface corresponding to the service request is included in the feature table.

Where, the target data record is a data record, in the feature table, that corresponds to the request interface corresponding to the service request.

In step S603, it is determined whether the request parameters in the service request include a request parameter the same as a feature field corresponding to the target data record.

The request interface is compared with the data in the feature table, and then the request parameters in the service request are compared with the feature field of the target data record. Whether the request interface meets the preset condition is determined after the above comparisons.

In step S604, in a case that the request parameters in the service request include the request parameter the same as the feature field corresponding to the target data record, it is determined that the request interface corresponding to the service request meets the preset condition.

In step S605, in a case that the request parameters of the service request do not include a request parameter the same as the feature field corresponding to the target data record, it is determined that the request interface corresponding to the service request does not meet the preset condition.

It can be understood that it is determined whether the request interface meets the preset condition to determine whether to record the service request. In this way, the service requests are preliminarily filtered for traffic recording, which can improve the universality of data obtained through the traffic recording.

In an embodiment, the method further includes: obtaining all the data in the recording data table when the preset time period ends, where all the data in the recording data table is used to perform replay testing on interfaces of the application clients.

In a testing environment, all data in the recording data table is obtained for testing the interfaces of the application clients. The real requests recorded online are replayed in the testing environment. In this way, the authenticity and reliability of test cases can be improved. For each request interface, only one copy of corresponding request data is recorded. In replay testing, the recorded data is matched with the requests issued by the application clients to test the interfaces. In other words, the request data corresponding to each request interface can be used to test the requests sent by multiple application clients to the request interface, thereby improving the universality of data obtained through traffic recording and the efficiency for testing application interfaces.

It should be understood that, although the steps in the flowcharts of the foregoing embodiments are sequentially shown according to the indication of arrows, the steps are not necessarily sequentially performed according to the order indicated by the arrows. Unless otherwise explicitly specified herein, the orders in which the steps are performed are not strictly limited, and the steps may be performed in other orders. In addition, at least some steps in these flowcharts of the foregoing embodiments may include multiple sub-steps or multiple stages. It is unnecessary to implement the sub-steps or the stages simultaneously. Rather, the sub-steps or the stages may be implemented in different time instants. In addition, it is unnecessary to implement the sub-steps or the stages sequentially. Rather, the sub-steps or the stages may be implemented in turn or alternately along with other steps or at least some sub-steps or stages of other steps.

The device for recording traffic according to the embodiments of the present disclosure is described below. The device for recording traffic described below and the method for recording traffic described above can be referred to each other.

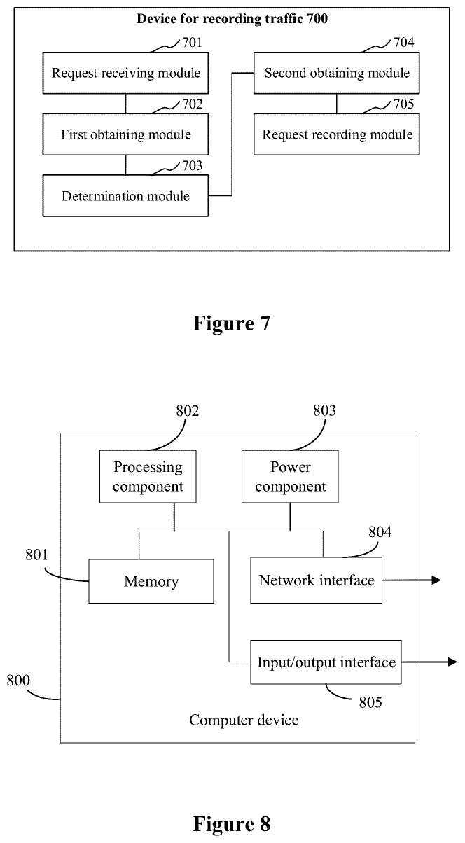

As shown in FIG. 7, a device 700 for recording traffic is provided according to the present disclosure. The device is applied to a server. The device includes a request receiving module 701, a first obtaining module 702, a determination module 703, a second obtaining module 704, and a request recording module 705.

The request receiving module 701 is configured to receive a service request issued by each of application clients of a target application within a preset time period in response to a traffic recording instruction for the target application and obtain a request interface and request parameters corresponding to the service request.

The first obtaining module 702 is configured to obtain a feature table, where the feature table includes multiple request interfaces and feature fields corresponding to the multiple request interfaces; and the feature field is a parameter that is included and of a same value in each service request which is sent by each application client to each request interface corresponding to each application client.

The determination module 703 is configured to determine, for each service request, whether a request interface corresponding to the service request meets a preset condition based on the feature table.

The second obtaining module 704 is configured to obtain a recording data table in a case that the request interface corresponding to the service request meets the preset condition; and determine whether the request interface corresponding to the service request is included in the recording data table.

The request recording module 705 is configured to record the service request in a case that the request interface corresponding to the service request is not included in the recording data table; and write the recorded data into the recording data table.

In an embodiment, the device further includes a third obtaining module, a data set division module, a feature cleaning module, a data writing module, a first update module and a second update module as follows.

The third obtaining module is configured to obtain target request data at a scheduled time instant and determine a preset temporary table. Where, the target request data includes all data records in a log of a server at a current time instant, and each of the data records in the log of the server includes a request interface, request parameters and return data.

The data set division module is configured to divide, for the target request data obtained each time, the target request data into multiple request data sets based on the request interfaces included in all data records in the target request data. Where, the data records in a same request data set correspond to a same request interface.

The feature cleaning module is configured to perform, for each of the multiple request data sets, feature cleaning on the request data set and determine whether there is a feature field corresponding to the request data set based on a result of the feature cleaning.

The data writing module is configured to write, for each of the multiple request data sets, the request interface and the feature field corresponding to the request data set into the temporary table in a case that there is a feature field corresponding to the request data set. The first update module is configured to update the log data of the server based on the temporary table.

The second update module is configured to update the feature table based on the temporary table.

In an embodiment, the feature cleaning module includes a first obtaining sub-module and a first determination sub-module as follows.

The first obtaining sub-module is configured to obtain, for each of the multiple request data sets, request parameters and return data corresponding to each of data records in the request data set.

The first determination sub-module is configured to determine a request parameter as the feature field corresponding to the request data set in a case that the request parameter is included in each of the data records in the request data set and is of a same value in the return data corresponding to each of the data records in the request data set.

In an embodiment, the first update module includes a second obtaining sub-module and a first update sub-module as follows.

The second obtaining sub-module is configured to obtain a first request interface. Where, the first request interface is a request interface corresponding to any one of the data records in the log data of the server.

The first update sub-module is configured to delete the data record corresponding to the first request interface from the log data of the server in a case that the first request interface is not included in the temporary table to update the log data of the server.

In an embodiment, the second update module includes a third obtaining sub-module and a second update sub-module as follows.

The third obtaining sub-module is configured to obtain a second request interface. Where, the second request interface is a request interface corresponding to any one of data records in the feature table.

The second update sub-module is configured to update a feature field that is in the feature table and corresponds to the second request interface as a feature field that is in the temporary table and corresponds to the second request interface in a case that the second request interface is included in the temporary table.

In an embodiment, the determination module 703 includes a first judgment sub-module, a second determination sub-module, a second judgment sub-module, a first result determination sub-module, and a second result determination sub-module as follows.

The first judgment sub-module is configured to determine the request interface corresponding to the service request is included in the feature table.

The second determination sub-module is configured to determine a target data record in a case that the request interface corresponding to the service request is included in the feature table, where the target data record is a data record that is in the feature table and corresponds to the request interface.

The second judgment sub-module is configured to determine whether the request parameters of the service request include a request parameter the same as a feature field corresponding to the target data record.

The first result determination sub-module is configured to determine that the request interface corresponding to the service request meets the preset condition in a case that the request parameters of the service request include a request parameter the same as the feature field corresponding to the target data record.

The second result determination sub-module is configured to determine that the request interface corresponding to the service request does not meet the preset condition in a case that the request parameters of the service request do not include the request parameter the same as the feature field corresponding to the target data record.

In an embodiment, the device further includes a replay testing module.

The replay test module is configured to obtain all data in the recording data table when the preset time period ends. Where, the data in the recording data table is configured to perform replay testing on interfaces of the application clients.

The division of the modules in the device for recording traffic is only for illustration. In other embodiments, the device for recording traffic may be divided into different modules as required to complete all or some of the functions of the device for recording traffic. All or some of modules in the device for recording traffic may be implemented by software, hardware, or a combination thereof. The modules may be embodied in or independent of a processor of a computer device in a hardware form, or may be stored in a memory of a computer device in a software form, facilitating the processor invoking and performing operations corresponding to the modules.

In an embodiment, a computer readable storage medium is further provided according to the present disclosure. The computer readable storage medium stores computer readable instructions, when executed by one or more processors, the computer readable instructions cause the one or more processors to perform the steps of the method for recording traffic according to any one of the above embodiments.

In an embodiment, a computer device is further provided according to the present disclosure. The computer device stores computer readable instructions, when executed by one or more processors, the computer readable instructions cause the one or more processors to perform the steps of the method for recording traffic according to any one of the above embodiments.

For example, as shown in FIG. 8, FIG. 8 is a schematic diagram of an internal structure of a computer device according to an embodiment of the present disclosure. The computer device 800 may be implemented as a server. Referring to FIG. 8, the computer device 800 includes a processing component 802 and a memory 801. The processing component 802 includes one or more processors. The memory 801 serves as a storage resource and is configured to store instructions, such as an application program, executable by the processing component 802. The application program stored in the memory 801 includes one or more modules, each of which corresponding to a set of instructions. Further, the processing component 802 is configured to execute the instructions to perform the steps of the method for recording traffic according to any one of the above embodiments.

The computer device 800 further includes a power component 803, a wired or wireless network interface 804, and an input/output (I/O) interface 805. The power supply component 803 is configured to perform power management for the computer device 800. The wired or wireless network interface 804 is configured to connect the computer device 800 to a network. The computer device 800 operates based on an operating system, such as Windows Server™, Mac OS X™, Unix™, Linux™, Free BSD™ and the like, stored in the memory 801.

Those skilled in the art can understand that the structure shown in FIG. 8 is only a block diagram of a partial structure related to the solutions according to the present disclosure, which is not considered as a limitation to the computer device to which the solutions according to the present disclosure is applied. In other words, the computer device may include more or fewer components than those shown in FIG. 8, or some components may be combined, or the components are arranged in a different manner.

Based on the technical solutions described above, the embodiments of the present disclosure have advantages as follows.

In the method and device for recording traffic according to the present disclosure, a service request issued by each application client of a target application within a preset time period is received in response to a traffic recording instruction for the target application. A request interface and request parameters corresponding to each service request are obtained. A feature table is obtained. Where, the feature table includes multiple request interfaces and feature fields corresponding to the multiple request interfaces. The feature field is a parameter that is included and is of a same value in each service request which is sent by each application client to each request interface corresponding to each application client. For each of the service requests, it is determined whether a request interface corresponding to the service request meets a preset condition based on the feature table. A recording data table is obtained in a case that the request interface corresponding to the service request meets the preset condition. It is determined whether the request interface corresponding to the service request is included in the recording data table. In a case that the request interface corresponding to the service request is not included in the recording data table, the service request is recorded and recorded data is written in the recording data table. By recording the parameter, i.e., feature field, that is included and is of a same value in all the requests sent by different application clients of the target application to a same request interface, request data can be selectively recorded based on the request interface and the feature field corresponding to the request interface. By determining whether the request interface is included in the recording data table, the request interfaces in the recorded data are different from each other. In other words, for each request interface, only one copy of request data is recorded. In replay testing, the recorded data can be matched with the requests issued by each of application clients for interface testing. In other word, the request data corresponding to each request interface can be used to test the requests sent by multiple application clients to the request interface, thereby enhancing the universality of data obtained through traffic recording and the efficiency for testing application interfaces.

It should be further illustrated that relation terms such as “first” and “second” herein are only used to distinguish one entity or operation from another entity or operation, and does not necessarily require or imply that there is an actual relation or order between these entities or operations. Moreover, the terms “comprise”, “include”, or any other variants thereof are intended to encompass a non-exclusive inclusion, such that the process, method, article, or device including a series of elements includes not only those elements but also those elements that are not explicitly listed, or the elements that are inherent to such process, method, article, or device. Unless explicitly limited, the statement “including/comprising a . . . ” does not exclude the case that other similar elements may exist in the process, the method, the article or the device other than enumerated elements. In the present disclosure, “a”, “one”, and “the/said” in a singular form may also include a plural form, unless the context clearly indicates otherwise. It should further be understood that the terms “include/comprise” or “have” specify the existence of a stated feature, entirety, step, operation, component, part or a combination thereof, but do not exclude the possibility of the existence or addition of one or more other features, entireties, steps, operations, components, parts or a combination thereof.

The embodiments in this specification are described in a progressive manner, each of which emphasizes the differences from others. The embodiments may be combined as required, and the same or similar parts among the embodiments can be referred to each other.

Based on the above description of the disclosed embodiments, those skilled in the art can implement or apply the present disclosure. Various modifications to the embodiments are obvious to those skilled in the art, and general principles defined in the present disclosure can be implemented in other embodiments without departing from the spirit or scope of the present disclosure. Hence, the present disclosure shall not be limited to the embodiments described herein, rather, has the widest scope that complies with the principle and novelty disclosed herein.

1. A method for recording traffic, performed by a server, wherein the method comprises:
receiving, in response to a traffic recording instruction for a target application, service requests issued by all application clients of the target application within a preset time period;
obtaining a request interface and request parameters corresponding to each of the service requests;
obtaining a feature table, wherein the feature table comprises a plurality of request interfaces and feature fields corresponding to the plurality of request interfaces, and the feature fields are parameters that are comprised and of a same value in the service requests sent by the application clients to corresponding request interfaces;
for any one of the service requests,
determining whether a request interface corresponding to the service request meets a preset condition based on the feature table;
obtaining a recording data table, in a case that the request interface corresponding to the service request meets the preset condition;
determining whether the request interface corresponding to the service request is comprised in the recording data table;
recording the service request, in a case that the request interface corresponding to the service request is not comprised in the recording data table; and
writing the recorded data into the recording data table, wherein in replay testing, the recorded data is matched with the service requests issued by each of the application clients for interface testing;
wherein the determining whether a request interface corresponding to the service request meets a preset condition based on the feature table comprises:
determining whether the request interface corresponding to the service request is comprised in the feature table;
determining a target data record in a case that the request interface corresponding to the service request is comprised in the feature table, wherein the target data record is a data record that is in the feature table and corresponds to the request interface corresponding to the service request;
determining whether the request parameters of the service request comprise a request parameter the same as a feature field corresponding to the target data record;
determining that the request interface corresponding to the service request meets the preset condition, in a case that the request parameters of the service request comprise a request parameter the same as the feature field corresponding to the target data record; and
determining that the request interface corresponding to the service request does not meet the preset condition, in a case that the request parameters of the service request do not comprise the request parameter the same as the feature field corresponding to the target data record.

2. The method for recording traffic according to claim 1, further comprising:
obtaining target request data at a scheduled time instant;
determining a preset temporary table, wherein the target request data comprises all data records in a current log of the server, and wherein each of the data records in the current log of the server comprises a request interface, request parameters and return data;
dividing, for the target request data obtained at the scheduled time instant, the target request data into a plurality of request data sets based on request interfaces comprised in the data records in the target request data, wherein the data records in a same request data set correspond to a same request interface;
for each of the plurality of request data sets,
performing feature cleaning on the request data set;
determining whether there is a feature field corresponding to the request data set based on a result of the feature cleaning;
writing, in a case that there is a feature field corresponding to the request data set, the request interface and the feature field corresponding to the request data set into the temporary table;
updating log data of the server based on the temporary table; and
updating the feature table based on the temporary table.

3. The method for recording traffic according to claim 2, wherein the performing feature cleaning on each of the plurality of request data sets comprises:
obtaining request parameters and return data corresponding to each of data records in the request data set; and
determining a request parameter as the feature field corresponding to the request data set, in a case that the request parameter is included in each of the data records in the request data set and is of a same value in the return data corresponding to each of the data records in the request data set.

4. The method for recording traffic according to claim 2, wherein the updating the log data of the server based on the temporary table comprises:
obtaining a first request interface, wherein the first request interface is a request interface corresponding to any one of the data records in the log data of the server; and
deleting, in a case that the first request interface is not included in the temporary table, the data record corresponding to the first request interface from the log data of the server, to update the log data of the server.

5. The method for recording traffic according to claim 2, wherein the updating the feature table based on the temporary table comprises:
obtaining a second request interface, wherein the second request interface is a request interface corresponding to any one of data records in the feature table; and
updating, in a case that the second request interface is included in the temporary table, a feature field that is in the feature table and corresponds to the second request interface as a feature field that is in the temporary table and corresponds to the second request interface.

6. The method for recording traffic according to claim 1, further comprising:
obtaining all data in the recording data table when the preset time period ends, wherein the data in the recording data table is configured to perform replay testing on interfaces of the application clients.

7. A device for recording traffic, which is applied to a service, wherein the device comprises:
a request receiver, configured to receive service requests issued by all application clients of a target application within a preset time period in response to a traffic recording instruction for the target application and obtain a request interface and request parameters corresponding to each of the service requests;
a first obtainer, configured to obtain a feature table, wherein the feature table comprises a plurality of request interfaces and a feature field corresponding to the plurality of request interfaces, and the feature field is a parameter that is comprised and of a same value in the service requests sent by the application clients to corresponding request interfaces;
a determiner, configured to, for any one of the service requests, determine whether a request interface corresponding to the service request meets a preset condition based on the feature table;
a second obtainer, configured to obtain a recording data table in a case that the request interface corresponding to the service request meets the preset condition; and determine whether the request interface corresponding to the service request is comprised in the recording data table; and
a request recorder, configured to record the service request in a case that the request interface corresponding to the service request is not comprised in the recording data table; and write the recorded data into the recording data table, wherein in replay testing, the recorded data is matched with the service requests issued by each of the application clients for interface testing;
wherein the determiner is further configured to determine whether the request interface corresponding to the service request is comprised in the feature table; determine a target data record in a case that the request interface corresponding to the service request is comprised in the feature table, wherein the target data record is a data record that is in the feature table and corresponds to the request interface corresponding to the service request; determine whether the request parameters of the service request comprise a request parameter the same as a feature field corresponding to the target data record; determine that the request interface corresponding to the service request meets the preset condition, in a case that the request parameters of the service request comprise a request parameter the same as the feature field corresponding to the target data record; and determine that the request interface corresponding to the service request does not meet the preset condition, in a case that the request parameters of the service request do not comprise the request parameter the same as the feature field corresponding to the target data record.

8. A non-transitory computer-readable storage medium, wherein the computer-readable storage medium stores computer-readable instructions, wherein the computer-readable instructions, when executed by one or more processors, cause the one or more processors to implement a method for recording traffic, the method comprises:
receiving, in response to a traffic recording instruction for a target application, service requests issued by all application clients of the target application within a preset time period;
obtaining a request interface and request parameters corresponding to each of the service requests;
obtaining a feature table, wherein the feature table comprises a plurality of request interfaces and feature fields corresponding to the plurality of request interfaces, and the feature fields are parameters that are comprised and of a same value in the service requests sent by the application clients to corresponding request interfaces;
for any one of the service requests,
determining whether a request interface corresponding to the service request meets a preset condition based on the feature table;
obtaining a recording data table, in a case that the request interface corresponding to the service request meets the preset condition;
determining whether the request interface corresponding to the service request is comprised in the recording data table;
recording the service request, in a case that the request interface corresponding to the service request is not comprised in the recording data table; and
writing the recorded data into the recording data table, wherein in replay testing, the recorded data is matched with the service requests issued by each of the application clients for interface testing;
wherein the determining whether a request interface corresponding to the service request meets a preset condition based on the feature table comprises:
determining whether the request interface corresponding to the service request is comprised in the feature table;
determining a target data record in a case that the request interface corresponding to the service request is comprised in the feature table, wherein the target data record is a data record that is in the feature table and corresponds to the request interface corresponding to the service request;
determining whether the request parameters of the service request comprise a request parameter the same as a feature field corresponding to the target data record;
determining that the request interface corresponding to the service request meets the preset condition, in a case that the request parameters of the service request comprise a request parameter the same as the feature field corresponding to the target data record; and
determining that the request interface corresponding to the service request does not meet the preset condition, in a case that the request parameters of the service request do not comprise the request parameter the same as the feature field corresponding to the target data record.

9. A computer device, comprising:
one or more processors; and
a memory storing computer-readable instructions, wherein the computer-readable instructions, when executed by one or more processors, cause the one or more processors to implement the method for recording traffic according to claim 1.
